(19) United States
(12) Patent Application Publication
(10) Pub. No.: US 2022/0327445 A1
(43) Pub. Date: Oct. 13, 2022

(54) WORKSHOP ASSISTANCE SYSTEM AND WORKSHOP ASSISTANCE METHOD

(71) Applicant: Hitachi, Ltd., Tokyo (JP)

(72) Inventors: Shuhei FURUYA, Tokyo (JP); Yo TAKEUCHI, Tokyo (JP); Masao ISHIGURO, Tokyo (JP); Toshiyuki ONO, Tokyo (JP)

(21) Appl. No.: 17/642,716

(22) PCT Filed: Oct. 9, 2020
(86) PCT No.: PCT/JP2020/038303

§ 371 Date: Mar. 14, 2022

(30) Foreign Application Priority Data
Nov. 1, 2019 (JP) 2019-199826

(51) Int. Cl. G06Q 10/06; G10L 15/08

(52) U.S. Cl. CPC G06Q 10/0631; G10L 15/08; G10L 2015/088

(57) ABSTRACT

The present invention pertains to a workshop assistance system constituted by a computer comprising a computing device for carrying out prescribed processing, a storage device connected to the computing device, and a communication interface connected to the computing device, the computer being capable of accessing problem case study data including case study information. The workshop assistance system comprises: a problem case study searching module that calculates an evaluation value based on the similarity between problem case study data and text data in which text corresponding to the contents of a discussion by participants is collected and saved into text data by the computing device according to each of preset perspectives; and a problem case study evaluation module by which the computation device determines, on the basis of the rating value, the form in which the problem case study data is outputted.

### CLAIM OF PRIORITY

The present application claims priority from Japanese patent application JP2019-199826 filed on Nov. 1, 2019, the content of which is hereby incorporated by reference into this application.

### BACKGROUND

The present invention relates to a workshop assistance system and a workshop assistance method.

In recent years, the time has come when companies are not selected as investment targets, business partners, collaborative creation partners, or places for employment of excellent human resources unless they are engaged in a business that solves social issues. On the other hand, many companies consider sustainable development goals (SDGs) as a big business opportunity and are entering the SDGs market.

However, when a new business is created to solve a social issue, it often ends without becoming a continuous business. It is thought that this is because it is necessary to envision a business that solves social issues by utilizing the strengths of existing businesses and core technologies. However, the strengths of existing businesses and core technologies have various perspectives such as technology, footprint, and data possessed, and it is important to consider from a plurality of aspects. There is a need for an assistance system for create such new businesses.

As a technology for realizing this, for example, Patent Document 1 discloses that a unit in which a theme and a keyword related to the theme are combined is stored in a database, and the user utilizes the unit to accelerate ideation.

Further, Patent Document 2 discloses a technology of identifying a solution concept related to input information and displaying the same as a hint based on the degree of relevance between a preset problem situation and the solution concept.

### CITATION LIST

### Patent Documents

Patent Document 1: Japanese Patent Application Laid-Open No. 2002-230029
Patent Document 2: Japanese Patent Application Laid-Open No. 2017-116975

### SUMMARY

According to the technology disclosed in Patent Document 1, ideation can be accelerated by referring to the information of the keywords stored in the database from the information of the related keywords considered in the process of associating a theme and the solution of the theme. Further, in the technology disclosed in Patent Document 2, hints related to a preset problem situation and a solution concept can be obtained.

However, when performing ideation, it may be easier to refer to a specific issue case rather than a keyword. It is conceivable to search for specific issue cases from keywords generated by participants or the like by utilizing the technologies of Patent Documents 1 and 2, but if there is a plurality of keywords, it may be difficult to determine whether the issue cases are searched for each keyword or combinations of a plurality of keywords.

In addition, when there is a plurality of keywords, the importance levels of respective keywords may be different. In such cases, it is necessary to reflect the importance level information in the search results.

The present invention has been made in view of the above, and an object thereof is to present information in an order according to the importance level of each perspective from the contents discussed by a facilitator and participants from a plurality of perspectives during a workshop.

According to one aspect of the present invention, a workshop assistance system includes a computer that includes, a processing device that executes a predetermined process, a storage device connected to the processing device, a communication interface connected to the processing device. The computer is accessible to issue case data including case information. The workshop assistance system includes an issue case search module allowing the processing device to collect text corresponding to contents of discussions of participants for each preset perspective, store the text in text data, and calculate an evaluation value from a degree of similarity between the text data and issue case data and an issue case evaluation module allowing the processing device to determine an output mode of the issue case data based on the evaluation value.

According to the present invention, the content of the search target issue case data to be presented to the participants can be changed according to the magnitude of an evaluation value in consideration of the importance level of the perspective from the contents discussed by the facilitator and the participants in the workshop from the plurality of perspectives. Thus, the participants can efficiently refer to the issue case data that appropriately includes the plurality of perspectives and ideation can be accelerated.

The details of at least one embodiment of a subject matter disclosed herein are set forth in the accompanying drawings and the following description. Other features, aspects, and effects of the disclosed subject matter become apparent from the following disclosure, drawings, and claims.

### BRIEF DESCRIPTION OF THE DRAWINGS

FIG. 1 is a block diagram for illustrating an example of the overall configuration of the workshop assistance system in an embodiment of this invention.

FIG. 2A is a sequence diagram showing an example of preparation process of the workshop assistance system in the embodiment of this invention.

FIG. 2B is a sequence diagram showing an example of workshop process of the workshop assistance system in the embodiment of this invention.

FIG. 3 is a diagram showing an example of the configuration of the social issue category data in the embodiment of this invention.

FIG. 4 is a diagram showing an example of the configuration of the medium category detailed data in the embodiment of this invention.

FIG. 5 is a diagram showing an example of the configuration of the social issue case data in the embodiment of this invention.

FIG. 6 is a diagram showing an example of the configuration of the search perspective data in the embodiment of this invention.

FIG. 7 is a flowchart showing an example of the process of the social issue case collection program in the embodiment of this invention.

FIG. 8 is a flowchart showing an example of the process of the social issue case classification program in the embodiment of this invention.

FIG. 9 is a flowchart showing an example of the process of the social issue case search program in the embodiment of this invention.

FIG. 10 is a flowchart showing an example of the process of the social issue case evaluation program in the embodiment of this invention.

FIG. 11 shows an example of a display screen 1100 for discussing social issues in the embodiment of this invention.

FIG. 12 is a diagram showing an example of a social issue case display screen in the embodiment of this invention.

FIG. 13 is a diagram showing an example of a screen for setting the score of importance level in the embodiment of this invention.

FIG. 14 is a diagram showing an example of a major and medium category display screen transitioning to the social issue case display screen in the embodiment of this invention.

FIG. 15 is a diagram showing an example of a screen for inputting an idea conceived by the participant in the embodiment of this invention.

### DETAILED DESCRIPTION OF THE PREFERRED EMBODIMENTS

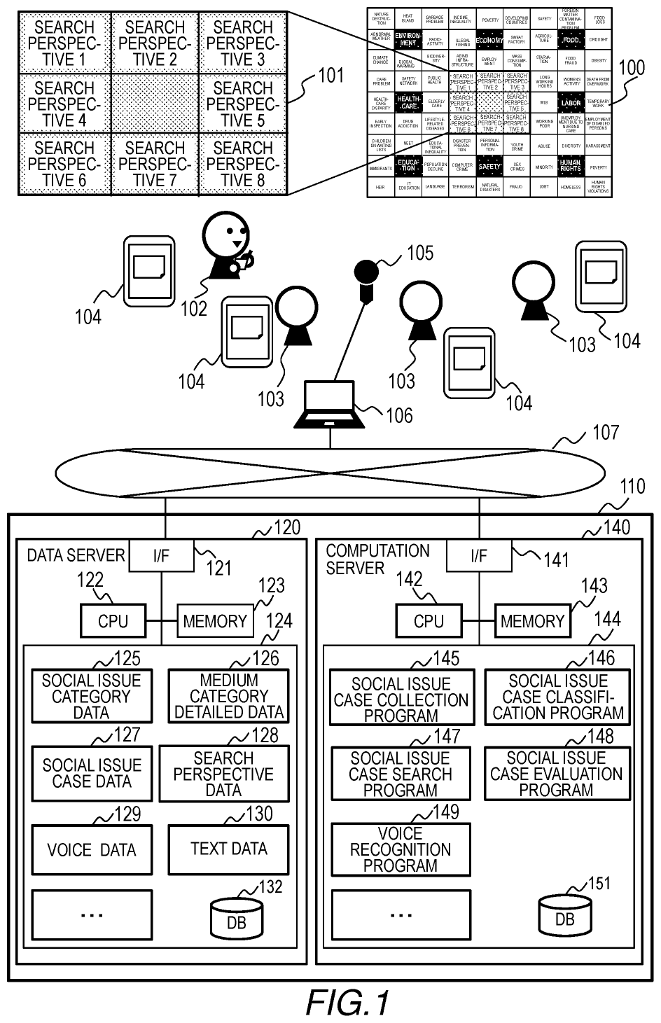

Embodiments of the present invention will be described in detail with reference to FIGS. 1 to 15. A workshop assistance system 110 of the present embodiment assists ideation in a workshop by presenting search target information to workshop participants 103 in descending order of evaluation in view of the importance level of each perspective according to a plurality of perspectives discussed by a facilitator 102 and the participants 103.

The details of the present embodiment will be described by way of an example of a workshop in which the strengths of existing businesses, business ideas, core technologies, and the like are discussed from a plurality of perspectives as the starting point of ideation, and ideation for new services centered on social issues is performed by referring to social issue cases related to the strengths, However, the present embodiment may also be used for ideation of other cases (such as when referring to another starting point of ideation or a case other than social issue cases).

FIG. 1 is a diagram showing an example of the overall configuration of the workshop assistance system 110. While looking at a framework 101 for organizing discussions for respective perspectives in the workshop, the facilitator 102 and the participants 103 of the workshop possess terminals 104 that display information necessary for ideation by this system.

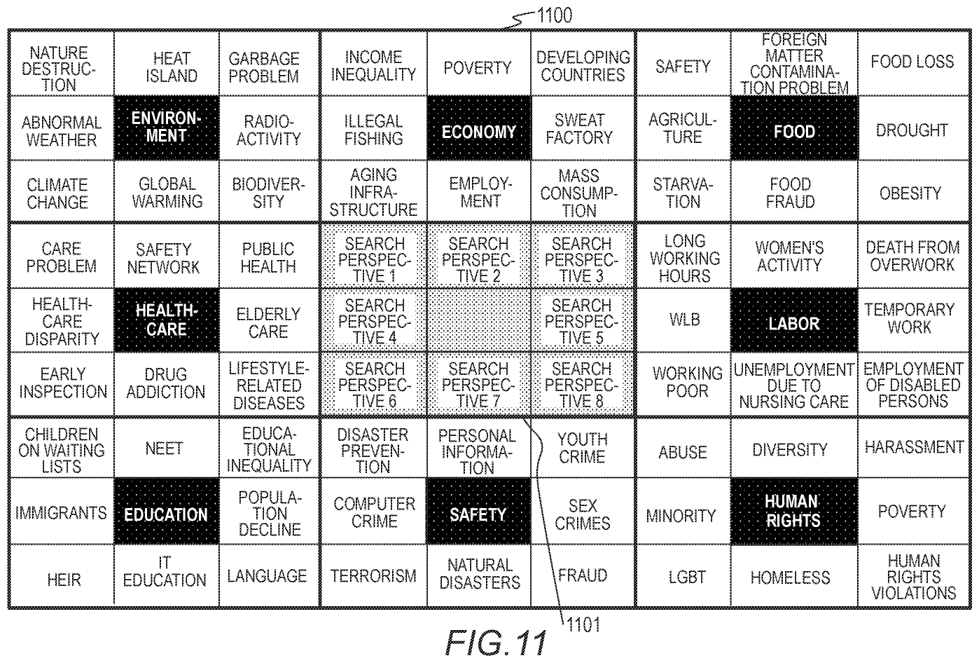

The terminal 104 is a tablet terminal or a portable computer, and has at least a function of connecting to a network 107 to input and output information. The frameworks 100 and 101 may be paper or a video display device. Display examples of the frameworks 100 and 101 will be described later with reference to FIG. 11.

In addition, a voice collecting device 105 is provided to record the content of the discussions during the workshop. The voice collecting device 105 may the microphone held by each of the facilitator 102 and the participants 103, or may be one housing in which a plurality of microphones for collecting the voices of respective persons are accommodated. Further, the voice collecting device 105 may use an Al speaker capable of interactively exchanging conversations. The voice collecting device 105 transmits the collected voice data to the workshop assistance system 110 via the network 107 using a general computer 106.

In the workshop, it is considered better to use the voice collecting device 105 in order to input the discussion content into the system in real time, but it may be input from the terminal 104 such as a tablet. In addition, instead of the workshop format, one person may input the discussion content on a terminal such as a tablet to perform ideation.

The information generated by this system is transmitted to the terminal 104 via the network 107 or the computer 106.

The workshop assistance system 110 has a data server 120 and a computation server 140, and is a computer system that is an execution subject of the present embodiment. The data server 120 and the computation server 140 are general server devices, and include central processing units (CPUs) 122 and 142, memories 123 and 143 which are storage devices comprised of volatile storage elements such as RAM, network interfaces 121 and 141, and auxiliary storage devices 124 and 144, respectively.

The CPUs 122 and 142 are processing devices and execute processing according to programs stored in the memories 123 and 143 to provide predetermined functions. Further, the network interfaces 121 and 141 are connected to the network 107 and perform communication processing with the computer 106 and the terminal 104 such as a tablet. Further, the auxiliary storage devices 124 and 144 are storage devices comprised of non-volatile storage devices such as a solid state drive (SSD) and a hard disk drive.

The auxiliary storage device 124 stores social issue category data 125, medium category detailed data 126, social issue case data 127, search perspective data 128, speech data 129, and text data 130. The auxiliary storage device 144 stores a social issue case collection program 145, a social issue case categorization program 146, a social issue case search program 147, a social issue case evaluation program 148, and a voice recognition program 149. All of these are stored in the databases 132 and 151. The database 151 of the computation server 140 may store the same data as the above-described data stored in the auxiliary storage device 124 of the data server 120.

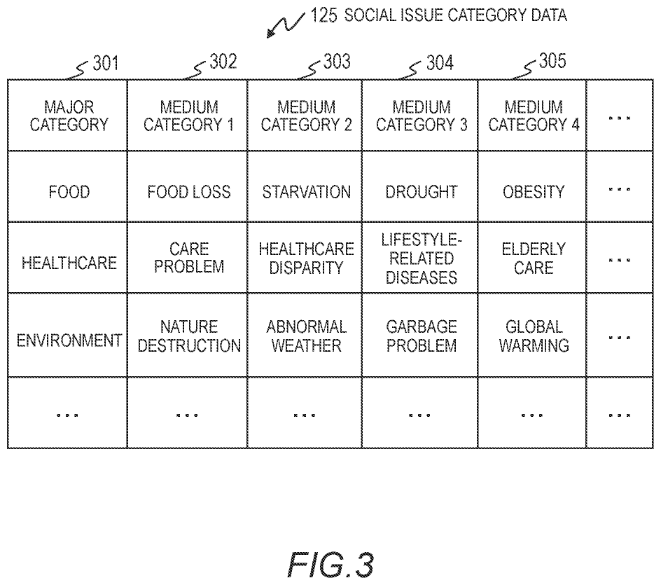

The social issue category data 125 stores information in which social issues are classified into major categories and medium categories. The details of the social issue category data 125 will be described later with reference to FIG. 3.

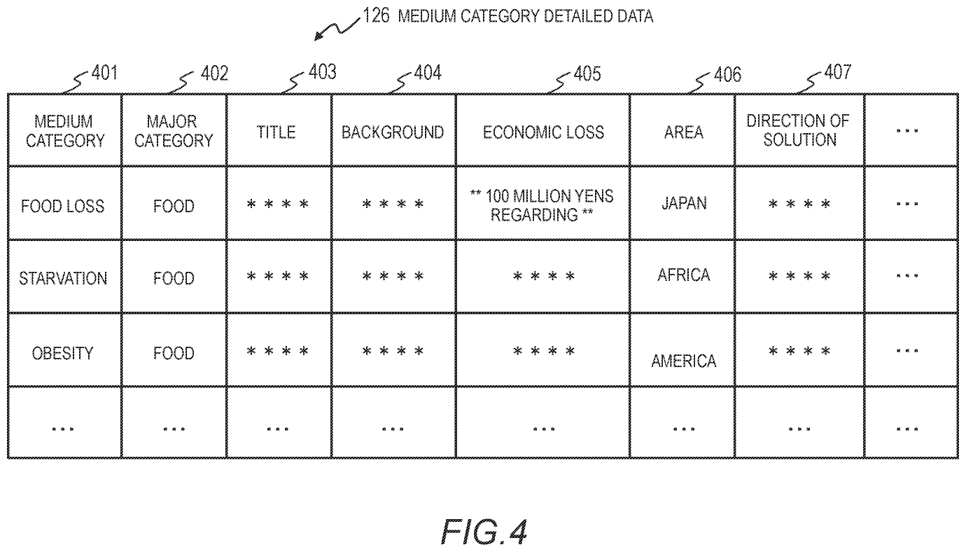

Further, the medium category detailed data 126 stores information such as the background, region, and economic loss (economic value) of the contents of the medium category obtained by decomposing the major category. The details of the medium category detailed data 126 will be described later with reference to FIG. 4.

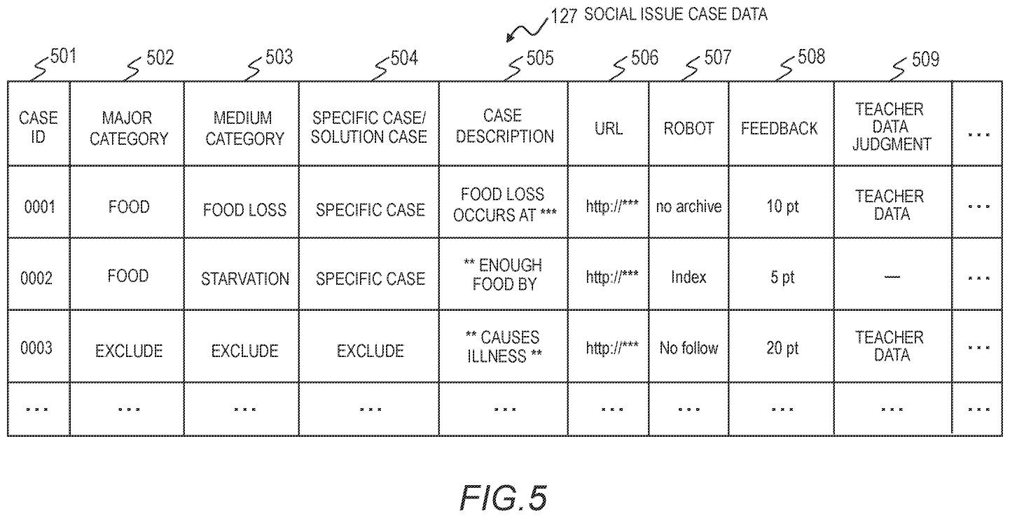

Further, the social issue case data 127 stores the URL of the website on which the case of the social issue presented to the participants 103 is described, and the text described in the URL. The details of the social issue case data 127 will be described later with reference to FIG. 5.

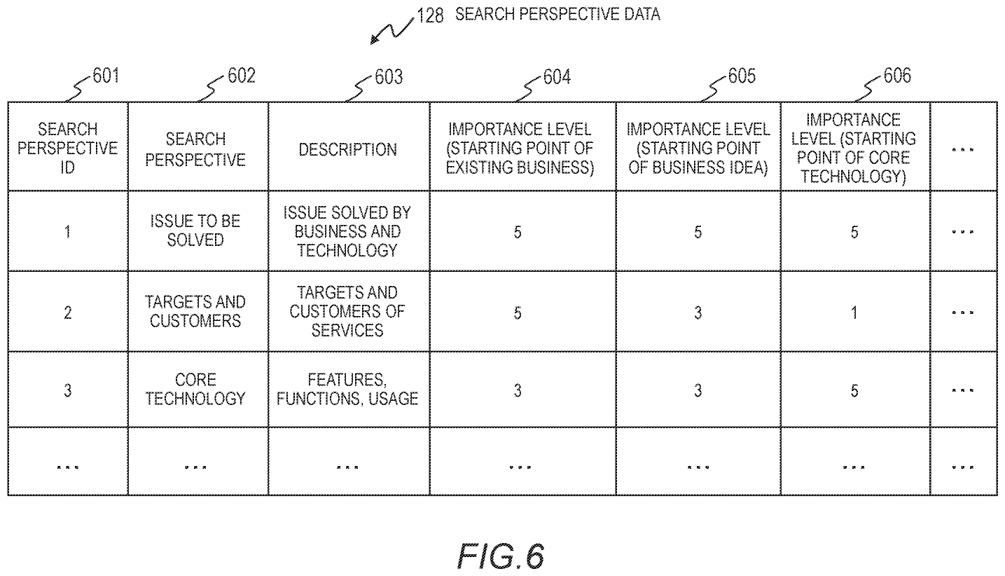

In addition, the search perspective data 128 stores information on the perspectives of discussions held a plurality of times by the participants 103 of the workshop on one theme (contents of existing businesses, business ideas, core technologies, and the like that are the starting point of the ideation). The details of the search perspective data 128 will be described later with reference to FIG. 6.

In the present embodiment, an example in which “issues to be solved”, “target (customer)”, and “core technologies” are the perspectives of discussion is shown, but the present invention is not limited to this. From the perspective of “issues to be solved”, for example, discussions are held on issues that have been solved in the past by businesses and technologies. From the perspective of “target (customer)”, discussions are held on services and customers that are the target of social issues. From the perspective of “core technologies,” discussions are held on the usage, function, and effects of core technologies for social issues.

In addition, in the workshop of the present embodiment, discussions will be divided and held for respective perspectives. That is, if there is a plurality of perspectives on one theme, the discussion is repeated according to the number of perspectives.

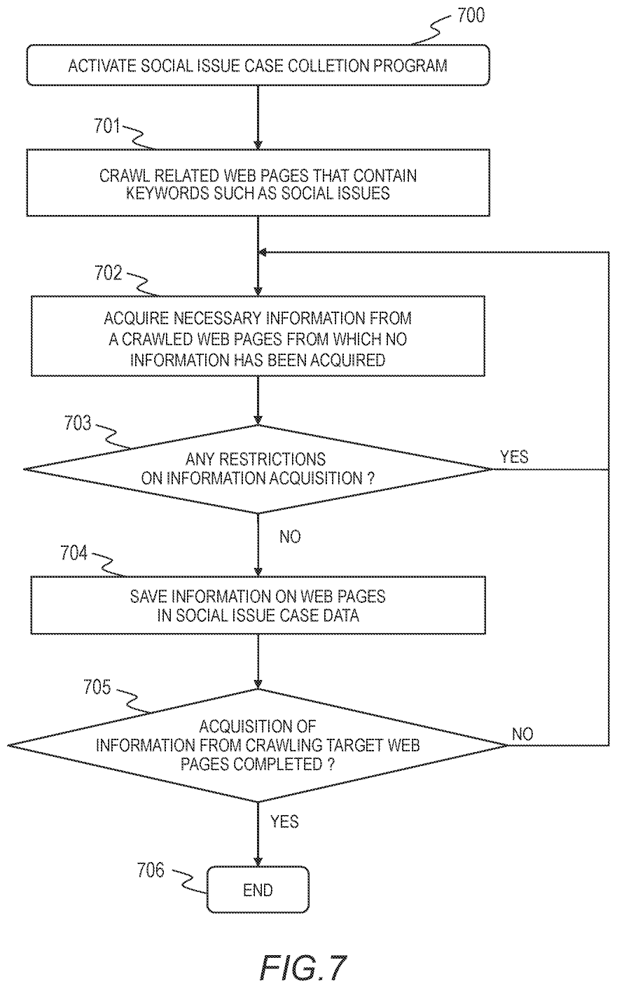

In addition, the social issue case collection program 145 is a program that crawls web pages containing a preset keyword such as a social issue and stores the text and URLs of the corresponding web pages in the social issue case data 127 of the database 132. The procedure of the process executed by the social issue case collection program 145 will be described later with reference to FIG. 7.

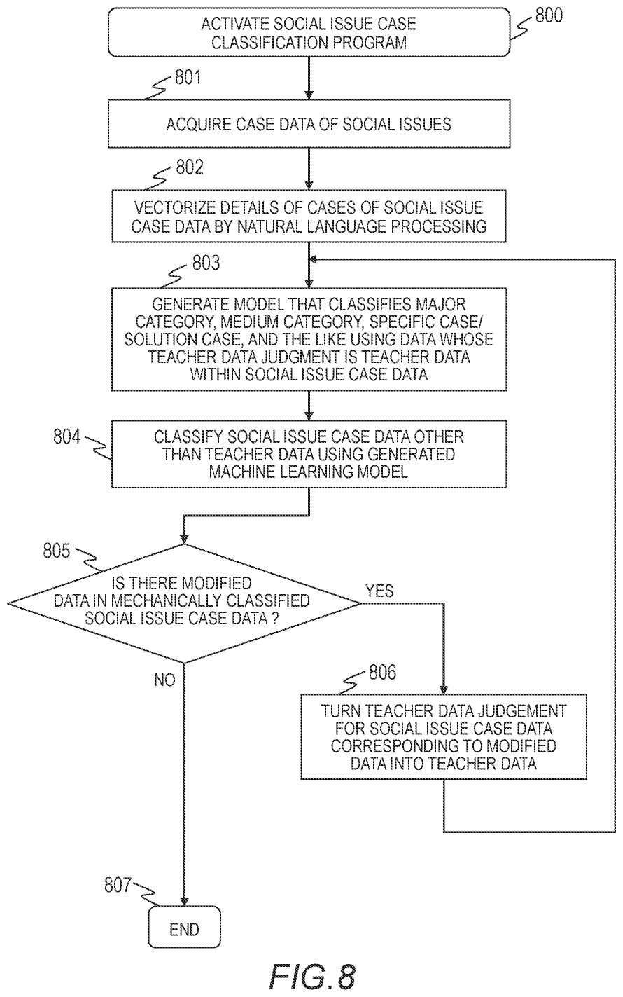

Further, the social issue case classification program 146 is a program that creates a machine learning model for classifying the social issue case data 127 based on the category information (the social issue category data 125 and the medium category detailed data 126) set for the social issue case data 127 and adds the category information to the unclassified data of social issue case data 127. The procedure of the process executed by the social issue case classification program 146 will be described later with reference to FIG. 8.

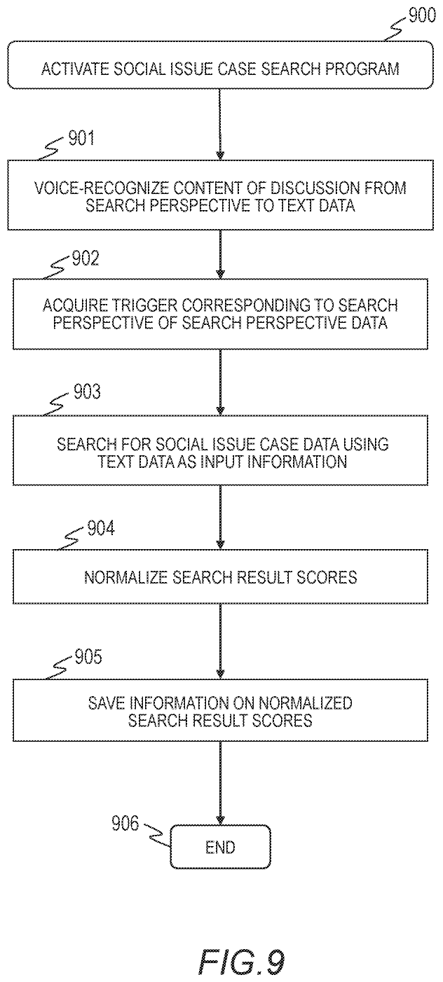

Further, the social issue case search program 147 is a program for searching for social issue cases from the social issue case data 127 according to the perspective of the content of the discussion in the workshop. The processing procedure executed by the social issue case search program 147 will be described later with reference to FIG. 9.

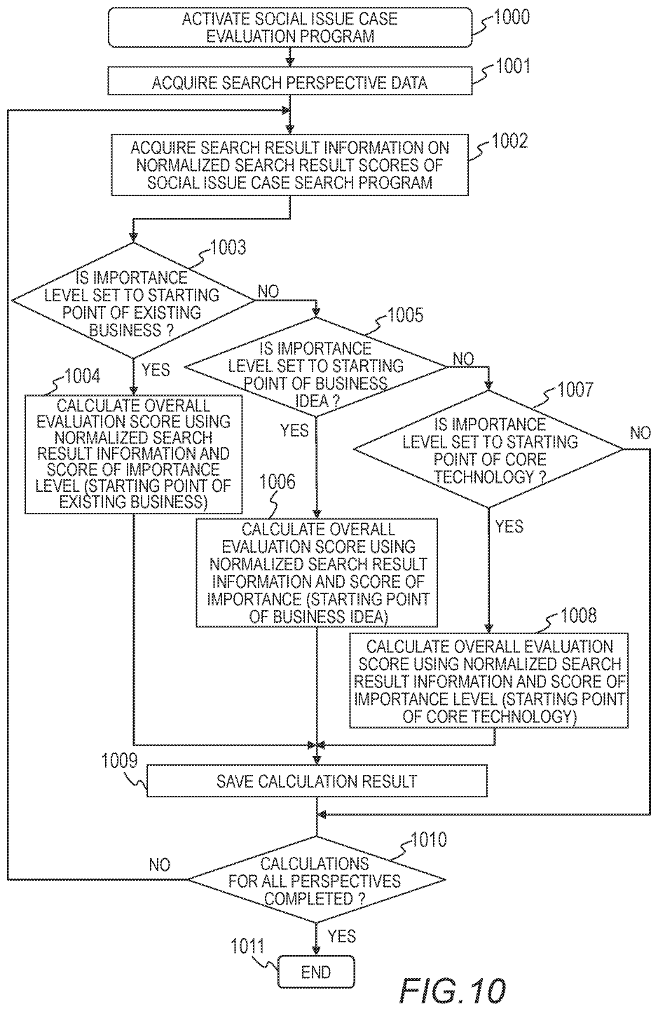

In addition, the social issue case evaluation program 148 is a program that calculates a score (comprehensive evaluation score) obtained by comprehensively evaluating the social issue cases based on the search results of the social issue case search program 147 according to the importance level included in the search perspective data 128, ranks the search results of the social issue case search program 147 according to the comprehensive evaluation score, and provides the same to the participants 103 of the workshop. The procedure of the process executed by the social issue case evaluation program 148 will be described later with reference to FIG. 10.

The voice recognition program 149 stores the voice collected by the voice collection device 105 via the computer 106 in the auxiliary storage device 124 of the data server 120 as speech data 129, and generates text data 130 from the speech data 129 by voice recognition technology.

The pieces of data 125 to 130 and the programs 145 to 149 described above may be stored in single auxiliary storage devices 124 and 144, respectively, or may be divided and stored in a plurality of storage devices. Further, the computation server 140 and the data server 120 may be physically configured on one computer, or may be configured on a plurality of logically or physically configured computers.

Further, although a form in which the facilitator 102 and the participants 103 each have the terminal 104 for viewing the search results provided by the social issue case evaluation program 148 has been illustrated, a video apparatus that can share information with all persons may be used. As the video apparatus, for example, a large touch panel type display or a projector having an operation detection function that can be operated interactively may be used.

The CPU 142 of the computation server 140 operates as a functional module that provides a predetermined function by performing processing according to each program. For example, the CPU 142 functions as a social issue case search module by performing processing according to the social issue case search program 147, and functions as a social issue case evaluation module by performing processing according to the social issue case evaluation program 148.

Hereinafter, the actual procedure in the present embodiment will be described with reference to the drawings.

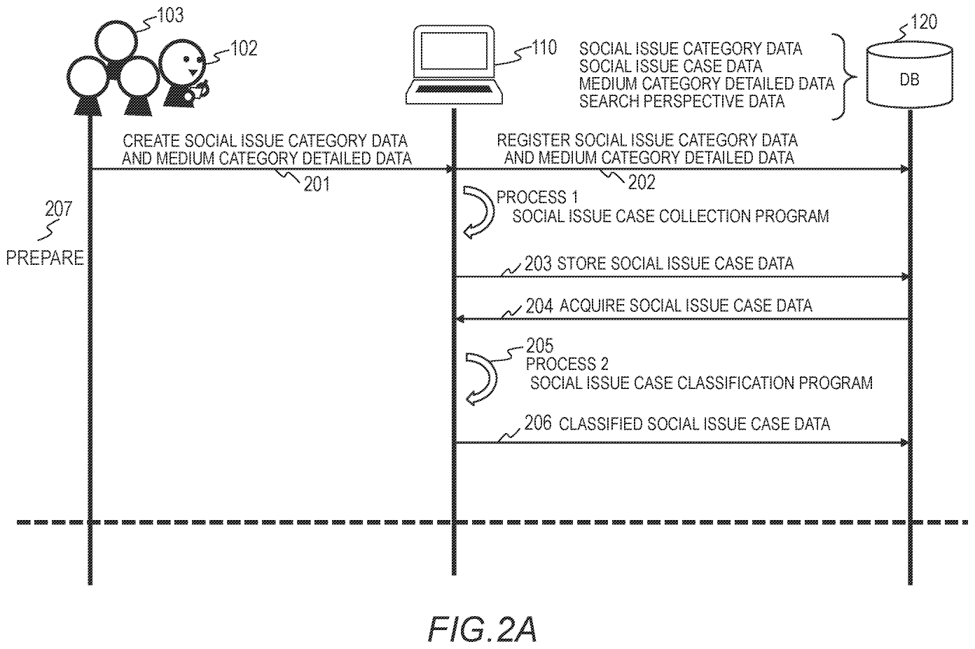

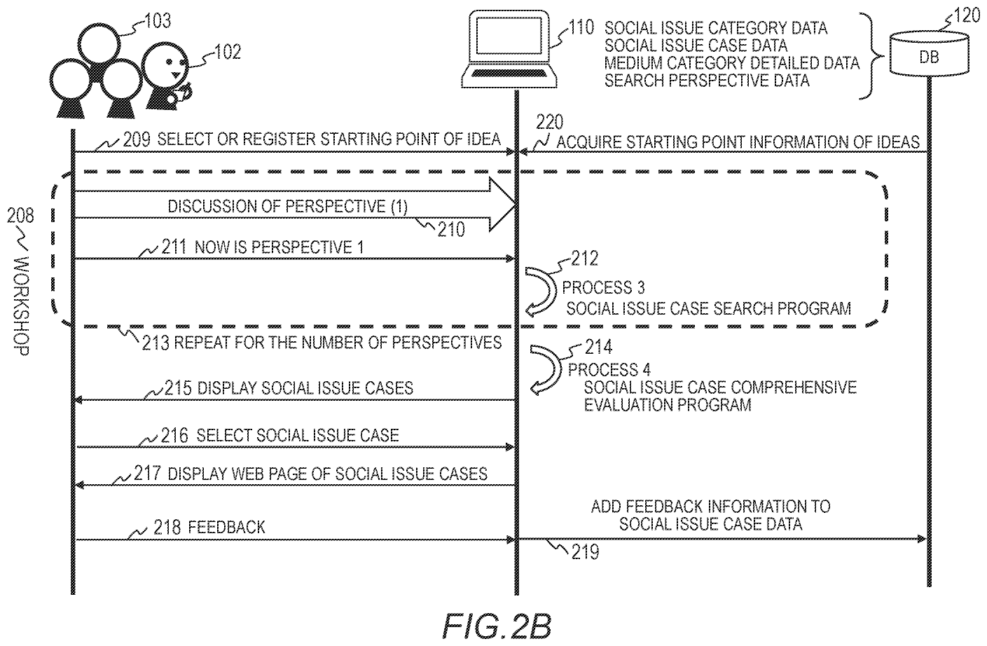

FIGS. 2A and 2B are sequence diagrams showing an example of information exchange and processing between the facilitator 102 and the participants 103 of the workshop, the workshop assistance system 110, and the data server 120. FIG. 2A shows the preparation process and FIG. 2B shows the process in the workshop. Further, in the present embodiment, information input by voice (contents of discussion) is described as an example, but other ways of expression or information input to the terminal 104 may be used.

Further, the voice recognition program 149 may perform searching after expanding the information using a synonym dictionary in which various synonyms of the text data 130 generated from the input speech data 129 are arranged. For example, by applying a natural language processing technology such as Word2Vec for vectorizing words and calculating the degree of similarity between words, it is determined whether the words are synonyms. Further, by utilizing Word2Vec, it is possible to perform four arithmetic operations on a word vector and create synonyms for words in different fields.

For example, the computation server 140 calculates what the word “safety” in the healthcare field corresponds to in the financial field as “safety”−healthcare+finance. If the calculation result is “insurance”, a synonym is created regarding that the word “safety” in healthcare corresponds to “insurance” in finance. In this way, the content of the conversation (discussion) from the search perspective can be found by searching in articles of various fields.

As shown in FIG. 2A, first, the operator of the workshop assistance system 110 such as the facilitator 102 creates the social issue category data 125 and the medium category detailed data 126, and then registers the same in the data server 120 via the workshop assistance system 110 (steps 201, 202).

Next, the social issue case collection program 145 starts Process 1. The social issue cases collected from the web pages on the network 107 and the like by the social issue case collection program 145 are stored as the social issue case data 127 of the data server 120 (step 203). In Process 1, as will be described later, the social issue case collection program 145 crawls web pages containing keywords such as social issues to collect social issues and cases.

Next, the workshop assistance system 110 acquires the social issue case data 127 stored in the data server 120 (step 204), and executes Process 2 using the social issue case classification program 146 (step 205).

As will be described later, the social issue case classification program 146 generates a machine learning model and classifies the social issue case data 127 other than teacher data. As a result of Process 2, the social issue case data 127 in which the social issues have been classified is stored in the data server 120 (step 206). This is the preparation for the workshop (207).

Next, the process during the workshop will be described with reference to FIG. 2B (208). First, the facilitator 102 selects or registers the starting point of the ideation according to the category of the theme of the workshop (step 209). The starting point of the ideation to be selected is acquired from the starting point set in advance in the search perspective data 128 (step 220). In the search perspective data 128, the importance level of a plurality of search perspectives is set for each starting point of ideation. If it is desired to register the starting point of new ideation, it may be additionally stored in the search perspective data 128. In addition, the importance level of the search perspective may be modified here according to the workshop.

In the present embodiment, an example in which “starting point of existing businesses”, “starting point of business ideas”, and “starting point of core technologies” are used as the starting point of ideation is shown, but the present invention is not limited to this. The importance level of each of the plurality of search perspectives may be set in advance for the starting point of one ideation, and may be changed as appropriate.

The facilitator 102 or the like can operate the terminal 104 to input and output data for selecting and registering the starting point of ideation (importance level of each of a plurality of search perspectives) and acquiring or adding the search perspective data 128.

Next, the facilitator 102 and the participants 103 discuss on each perspective of the examination (search) set in advance in the search perspective data 128, and the workshop assistance system 110 acquires the speech data 129 (step 210).

As a start trigger for the workshop assistance system 110 to start acquiring the speech data 129, the facilitator 102 or the like may input a predetermined speech such as “start discussion”. Further, when the discussion is over, the facilitator 102 or the like inputs a predetermined speech such as “Now is Perspective 1” which is input to the workshop assistance system 110 as an end trigger for the discussion (step 211).

The voice recognition program 149 runs on the computation server 140 of the workshop assistance system 110, and stores the voice acquired during the workshop in the speech data 129 of the auxiliary storage device 124.

Next, when the discussion on one perspective is completed, the social issue case search program 147 in the computation server 140 executes Process 3 using the discussion content as input information (step 212). As will be described later, in Process 3 executed by the social issue case search program 147, the degree of similarity between the text data 130 obtained by converting the speech data 129 of the content of the discussion in the workshop and the social issue case data 127 is calculated for each perspective of the workshop, and a score obtained by normalizing the degree of similarity is output as the search result.

The workshop assistance system 110 repeats the processes of steps 210 to 212 for the number of search perspectives 602 of the search perspective data 128 (step 213). However, the search for the social issue case data 127 regarding the perspective in which the value of the starting point (importance level 604, 605, 606) of the ideation selected in step 209 is 0 may be omitted.

Next, when Process 3 is completed from all perspectives, Process 4 is executed by the social issue case evaluation program 148 (step 214). In Process 4 executed by the social issue case evaluation program 148, the score (comprehensive evaluation score) obtained by comprehensively evaluating the social issue case according to the importance level included in the search perspective data 128 is calculated using the search result of the social issue case search program 147 as an input.

Next, the social issue case (social issue case data 127) comprehensively evaluated based on the search result is displayed on the terminals of the facilitator 102 and the participants 103 according to the evaluation result (comprehensive evaluation score) (step 215). As described above, the social issue cases according to the evaluation result may be displayed by a projector or a large display. The facilitator 102 or the participants 103 displays the web page of the social issue case (step 217) by selecting the social issue case displayed on the terminal 104 (step 216).

The participant 103 can input feedback on the social issue cases displayed on the terminal 104 as to whether they were used for major categories, medium categories, specific cases, solution cases, and ideation (step 218), and the workshop assistance system 110 additionally stores the feedback information in the social issue case data 127 (step 219). The feedback information is a social issue case referred to by the participants 103 of the workshop, and includes information for giving a score to the social issue case data 127 when it can be used for the ideation.

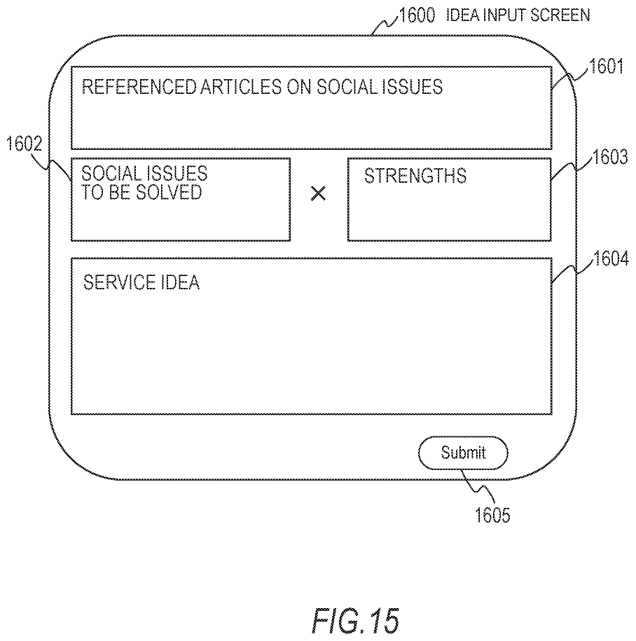

Further, the workshop participant 103 can transmit an idea for solving a social issue from the terminal 104 to the workshop assistance system 110. For example, the proposal of the participant 103 can be transmitted from an idea input screen of FIG. 15 described later.

Next, the details of the data used in the workshop assistance system 110 will be described with reference to FIGS. 3 to 6.

FIG. 3 is a diagram showing an example of the configuration of the social issue category data 125. The social issue category data 125 is data set in advance.

The social issue category data 125 includes a major category 301 and medium categories 302 to 305 associated with the major category. The major category 301 is a category related to fields such as food and healthcare, which are summarized in a relatively large group, and the medium categories 302 to 305 store keywords for specific social issues that are problems in the fields of the major category.

There is no limit in the numbers of major categories 301 and medium categories 302 to 305, and the numbers of medium categories 302 to 305 may be different for each major category 301.

FIG. 4 is a diagram showing an example of the configuration of the medium category detailed data 126. The medium category detailed data 126 is data set in advance. The medium category detailed data 126 includes a major category 402, a title 403, a background 404, an economic loss 405, a region 406, and a direction of solution 407 associated to the medium category 401.

The major category 402 is a major category to which the medium category 401 belongs. The title 403 is a title representing the medium category. The background 404 is a description of the medium category 401 and background information in which a social issue of the medium category 401 occurs. The economic loss 405 is information on the amount of economic loss (or the estimated amount of loss) incurred in society as a whole according to the medium category 401. Since the economic loss 405 is a social benefit when the issue is solved, it may be treated as an economic value.

The region 406 is information on the region where the social issues of the medium category 401 are occurring. The direction of solution 407 is information that can be considered as the direction of solving the social issue of the medium category 401.

FIG. 5 is a diagram showing an example of the configuration of the social issue case data 127. The social issue case data 127 is data collected from the network by the social issue case collection program 145 and classified by the social issue case search program 147.

The social issue case data 127 includes a major category 502, a medium category 503, a specific case/solution case 504, a case description 505, a URL 506, a Robot 507, a feedback 508, and a teacher data judgment 509 associated with a case ID 501.

The case ID 501 is an ID assigned to each social issue case by the computation server 140. The major category 502 is a major category to which each case belongs. The medium category 503 is a medium category to which each case belongs.

The specific case/solution case 504 is information indicating whether the case description 505 is the specific content of a social issue (who, where, and how someone is in trouble) or the solution case (who, how, and what kind of social issue is solved by or is worked on).

The case description 505 is a descriptive content of a web page (URL 506) in which a social issue case is presented. The Robot 507 is a crawler restriction content described in the URL 506. The feedback 508 is a score to be added when the social issue cases can be used for ideation from the participants 103 of the workshop.

The teacher data judgment 509 is data used in the social issue case classification program 146, and is information for determining whether the data can be used as teacher data when classifying the major category 502, the medium category 503, and the specific case/solution case 504. There may be exclude items as a major category, a medium category, and a specific case/solution case. This is to mechanically exclude web pages that are inappropriate for the ideation. This data is excluded from the search.

FIG. 6 is a diagram showing an example of the configuration of the search perspective data 128. The search perspective data 128 is data set in advance. The search perspective data 128 includes a search perspective 602, a description 603, and importance levels 604 to 606 associated with a search perspective ID 601.

The search perspective 602 is a perspective to be discussed in the workshop. The description 603 is information for describing the content of the search perspective. The importance levels 604 to 606 are scores indicating the importance level of the search perspective 602, which is set for each starting point (for example, existing businesses, business ideas, core technologies, and the like) of each ideation.

For example, when the starting point of ideation is an existing business, and a service that solves a social issue from the existing business is ideated, the issue to be solved by the existing business (search perspective ID 601=“1”) becomes an important perspective, and a high importance level is set. In the present embodiment, there are three starting points of ideation, but another starting point of ideation may be added. Further, although there are three search perspectives (search perspective ID 601=“1” to “3”), another search perspectives may be added.

FIG. 7 is a flowchart showing an example of the process of the social issue case collection program 145. This process is executed in Process 1 of the preparation stage of FIG. 2A. First, the social issue case collection program 145 of the workshop assistance system 110 is activated (step 700). This may be automatically activated at a predetermined time, or may be manually activated by the workshop participants 103 and the like. Next, the social issue case collection program 145 crawls web pages containing a preset keyword such as a social issue (step 701).

Next, the social issue case collection program 145 acquires necessary information from the crawled web pages (step 702). Next, the social issue case collection program 145 extracts prohibitions or restrictions related to information acquisition from the descriptions on the web pages, and determines whether the information can be acquired (step 703).

If the information cannot be acquired, the process returns to step 702 and moves to the next web page. When the information can be acquired, the social issue case collection program 145 stores information such as sentence information, a URL, and a title of the web page in the social issue case data 127 of the database 132 (step 704).

Next, the social issue case collection program 145 determines whether or not the acquisition of information about the web page to be crawled is completed (step 705). If not completed, the process returns to step 702 and moves to the next web page. When completed, the process ends here (step 706).

By the above-described processing, the information of the web pages containing a predetermined keyword such as a social issue is accumulated in the social issue case data 127 of the database 132.

FIG. 8 is a flowchart showing an example of the process of the social issue case classification program 146. This process is executed in Process 2 (step 205) in the preparation stage of FIG. 2A.

First, the social issue case classification program 146 is activated (step 800). This may be activated automatically after the process of the social issue case collection program 145 is completed, or it may be activated manually.

Next, the social issue case classification program 146 acquires the social issue case data 127 from the database 132 (step 801). Next, the social issue case classification program 146 utilizes a technology of vectorizing (distributed representation of) sentences using natural language processing such as Doc2Vec, and vectorizes the sentences included in the case description 505 of the social issue case data 127 (step 802).

Next, the social issue case classification program 146 generates a machine learning model for classifying the major category 502, the medium category 503, the specific case/solution case 504, and the like using the data in which the teacher data judgment 509 of the social issue case data 127 is “teacher data” (step 803). The setting of the teacher data of the social issue case data 127 is set in advance at the preparation stage or the like.

Next, the social issue case classification program 146 classifies the social issue case data 127 other than the teacher data by utilizing the generated machine learning model (step 804). By the classification process, the values of the major category 502, the medium category 503, and the specific case/solution case 504 are set in the data of the social issue case data 127 collected by crawling.

Next, the social issue case classification program 146 determines whether or not there is modified data for the social issue case data 127 mechanically classified in step 804 (step 805). The modified data for the social issue case data 127 is registered in advance in the database 132.

If there is modified data (Yes), the social issue case classification program 146 sets the teacher data judgment 509 of the social issue case data 127 corresponding to the modified data to “teacher data” (step 806). In the case of No, the process ends (step 807).

In the above-described processing, the method of vectorizing the sentences included in the case description 505 of the social issue case data 127 and classifying them by machine learning is described, but it may be classified by another machine learning method.

FIG. 9 is a flowchart showing an example of the process of the social issue case search program 147. This process is executed in step 212 (Process 3) of FIG. 2B.

First, the social issue case search program 147 is activated (step 900). This may be triggered by a voice input such as “Discussion will start from now on” or “Now is Perspective 1” by the facilitator 102 or the participant 103, or it may be manually activated arbitrarily or may be activated at other timings.

Next, the social issue case search program 147 acquires the speech data 129 of the discussion stored in the auxiliary storage device 124 (or 144), and causes the voice recognition program 149 to voice-recognize the content of the discussion from the search perspective to generate text data (step 901).

Since the speech data 129 stored in the auxiliary storage device 124 is divided for each perspective, the section to be voice-recognized is a section from the start trigger to the end trigger. Further, the text data 130 may be generated by the voice recognition program 149 after the start trigger of the workshop, and the text data 130 may be generated before the start of the social issue case search program 147.

Next, the social issue case search program 147 acquires a trigger corresponding to the search perspective 602 of the search perspective data 128 (step 902). For example, the trigger is a voice input such as “Now is Perspective *” (* corresponds to the search perspective ID 601) and “Now is “Issue to be solved”” (“Issue to be solved” corresponds to the search perspective 602). The trigger input is not limited to voice input, and may be input from the terminal 104 such as a tablet.

Next, the social issue case search program 147 searches the social issue case data 127 using the text data generated in step 901 as input information (step 903). As a search algorithm, for example, term frequency-inverse document frequency (TF-IDF) can be used.

Since TF-IDF can take the occurrence frequency of words into consideration, even if the text data or the case description 505 of the social issue case data 127 is a long sentence, the score of frequently used words is evaluated low, so that the case can be evaluated appropriately. Further, the TF-IDF can quantitatively evaluate the case (text data) to be searched by the score.

In the social issue case search program 147 of the present embodiment, the content of the discussion regarding the perspective of the workshop is converted into text data, the degree of similarity between the text data and the case description 505 of the social issue case data 127 is calculated by TF-IDF, and the degree of similarity is output as a score for each case description 505.

Next, the social issue case search program 147 normalizes the score of the search result (step 904). Next, the social issue case search program 147 stores the normalized search result information in the auxiliary storage device 124 (step 905). After this, the process ends (step 906).

By the above-described processing, the content of the discussion in the workshop from the start trigger to the end trigger is converted into text data, the importance level of the words contained in the text data is normalized, and the content is output as search result information. In addition, the search result information is generated for each perspective discussed in the workshop. The social issue case search program 147 may assign a perspective identifier to the search result information to be output and manage the search result information for each perspective.

In the above, an example of using TF-IDF as a method for calculating the importance level of a word is shown, but the present invention is not limited to this, and an algorithm for determining the characteristics of a document from the importance level of the words contained in the document may be adopted.

FIG. 10 is a flowchart showing an example of the process of the social issue case evaluation program 148. This process is executed in step 214 (Process 4) of FIG. 2B.

First, the social issue case evaluation program 148 is activated (step 1000). This may be triggered by a predetermined voice input such as “This is the end of discussion” by the facilitator 102 or the participant 103, or it may be manually activated arbitrarily.

Next, the social issue case evaluation program 148 acquires the search perspective data 128 (step 1001). Which of the importance level (starting point of existing business) 604, importance level (starting point of business idea) 605, and importance level (starting point of core technologies) 606 among the importance levels 604 to 606 of the search perspective data 128 will be used may be set in advance. Alternatively, it may be set by voice input, or may be set by the terminal 104 or the like. At that time, the score of the importance level of the search perspective data 128 may be changed.

Next, the social issue case evaluation program 148 acquires the search result information in which the score of the search result of the social issue case search program 147 is normalized from the auxiliary storage device 124 (step 1002). This search result information is acquired according to the number of search perspectives 602 discussed.

Next, the social issue case evaluation program 148 calculates a comprehensive evaluation score for the perspective of which of the importance levels 604 to 606 to be used is determined based on preset information.

First, the social issue case evaluation program 148 determines whether the importance level of the search perspective to be used is the importance level (the starting point of existing business) 604 (step 1003). In the case of Yes, the social issue case evaluation program 148 calculates the comprehensive evaluation score using the normalized search result information and the score of the importance level (the starting point of existing business) 604 (step 1004).

As a method of calculating the comprehensive evaluation score, for example, a method of calculating the sum of (score of normalized search result)×(importance level). For example, when the search result information is discussed with three search perspective IDs 601=“1” to “3”, the social issue case evaluation program 148 calculates the comprehensive evaluation score for the three items of search result information as follows.

When the score of the normalized search result is 8 points for the search perspective ID 601=“1”, 2 points for the search perspective ID 601=“2”, and 4 points for the search perspective ID 601=“3”, and the importance level (the starting point of existing business) 604 is 5 points for the search perspective ID 601=“1”, 5 points for the search perspective ID 601=“2”, and 3 points for the search perspective ID 601=“3”, the comprehensive evaluation score is calculated as 8×5+2×5+4×3=62 points.

That is, the scores for each search perspective are added up for each piece of the social issue case data 127 of the search result information, of which the degree of similarity is normalized, to obtain the comprehensive evaluation score.

However, the above-described calculation method is an example, and parameters may be set in each term, or other calculation methods may be used. Further, a machine learning model for calculating the feedback 508 of the social issue case data 127 may be created using the score of the search result and the importance level (604 to 606) as an input, and the result may be used as the comprehensive evaluation score.

On the other hand, when the determination in step 1003 is No, the social issue case evaluation program 148 determines whether the importance level of the set search perspective is the starting point of business idea (605) (step 1005). When the importance level (starting point between businesses) 605 is set as the target of use, the social issue case evaluation program 148 calculates the comprehensive evaluation score using the importance level of the search perspective as the importance level (starting point of business idea) 605 as in step 1004 (step 1006).

On the other hand, when the determination in step 1005 is No, the social issue case evaluation program 148 determines whether the importance level of the set search perspective is the importance level (starting point of core technologies) 606 (step 1007). In the case of Yes, the social issue case evaluation program 148 calculates the comprehensive evaluation score using the score of the importance level (starting point of core technologies) 606 as in step 1006 (step 1008). On the other hand, if the determination in step 1007 is No, the process ends. When the comprehensive evaluation score is calculated in steps 1004 to 1008, the social issue case evaluation program 148 stores the calculation result of the comprehensive evaluation score for each perspective in the auxiliary storage device 124 (step 1009).

In step 1010, it is determined whether the social issue case evaluation program 148 has calculated the comprehensive evaluation score for the search result information of all perspectives. If there is an unprocessed perspective, the process returns to step 1002 and the above-described processing is repeated. If the process is completed for all the perspectives, the process proceeds to step 1011 to end the process.

In the above, three conditional branches of steps 1003, 1005, and 1007 are set according to the importance levels 604 to 606 of the search perspective data 128, but the number of conditional branches may be increased or decreased according to the number of importance levels of the search perspective data 128. Further, the social issue case evaluation program 148 may add the feedback 508 of the social issue case data 127 to the comprehensive evaluation score. The degree of addition may be calculated by setting a parameter and multiplying the feedback with the parameter.

By the above-described processing, the importance levels 604 to 606 to be used for calculating the comprehensive evaluation score are set for each search perspective ID 601, and the comprehensive evaluation score of the social issue case data 127 is calculated for the search result information for each perspective discussed in the workshop.

FIG. 11 shows an example of a display screen 1100 for discussing social issues. The display screen 1100 is a screen that the social issue case evaluation program 148 outputs to the terminal 104 or the like.

The display screen 1100 has a configuration in which squares divided into major categories 301 (environment, economy, food, and the like in the figure) of the social issue category data 125 are arranged around the squares (search perspectives 1101) on which the search perspectives 1 to 8 to be discussed in the workshop are displayed.

Further, the medium categories 303 of the social issue category data 125 are arranged around the name of the major category. For example, the names of the medium categories of “safety,” “agriculture,” “starvation,” “food fraud,” “obesity,” “drought,” “food loss”, and “foreign matter contamination” are displayed in the eight squares around the major category=“food” in the upper right corner of the figure.

In the illustrated example, the number of search perspectives 1101 and the number of major categories, and the number of medium categories arranged on the display screen 1100 is eight, but the number is not limited to eight, and the arrangement may be changed as appropriate. Further, the contents of the major category and the medium category to be displayed may be changed according to the comprehensive evaluation score for each perspective calculated by the social issue case evaluation program 148.

For example, a threshold value may be set for the number of pieces of social issue case data 127 hit in the search, the average score of the medium category, and the like, and if it is below the threshold value, it may not be displayed or may be grayed out. Further, regarding the arrangement of the medium categories, the medium categories may be arranged from the upper left corner in descending order of average values of the comprehensive evaluation scores, may be displayed in a bold typeface so as to stand out, and may be displayed in descending order. Similarly, for the major categories, the arrangement, color, character thickness, and the like may be changed according to the average value of the comprehensive evaluation scores.

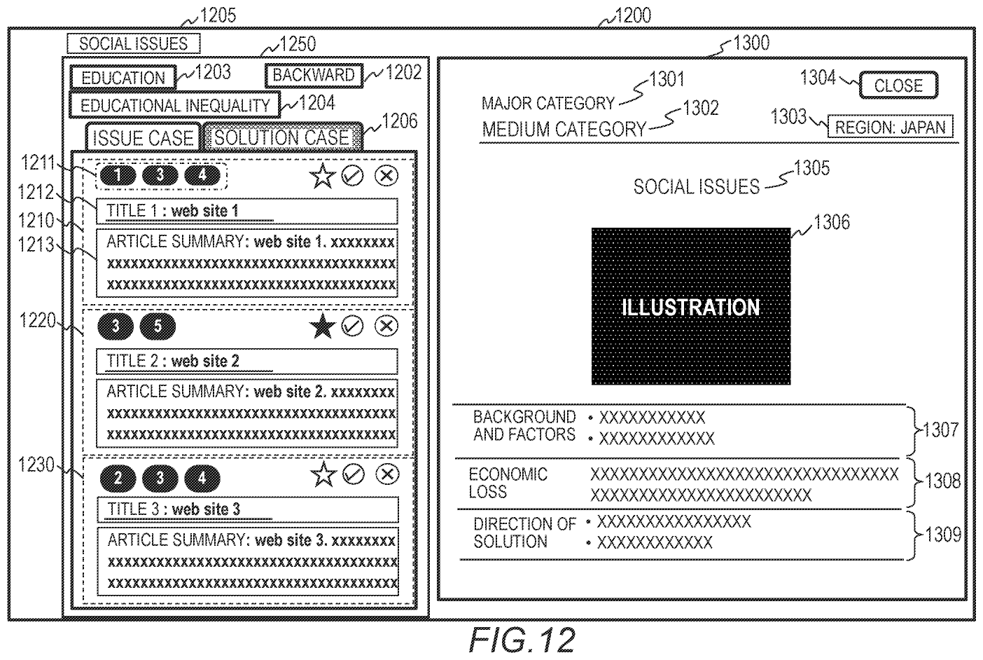

FIG. 12 is a diagram showing an example of a social issue case display screen 1200. The social issue case display screen 1200 is a screen that the social issue case search program 147 outputs to the terminal 104 or the like.

The social issue case evaluation program 148 may display the social issue case display screen 1200 when the medium category of the display screen 1100 shown in FIG. 11 is selected or may transition to the social issue case display screen 1200 from FIG. 15 described later. Further, the facilitator 102 may operate the terminal 104 to display the social issue case display screen 1200 on the terminal 104 of the participant 103.

The social issue case display screen 1200 has a display region 1250 for displaying the major category and the medium category selected in FIG. 11 and displaying the summary of a web page related to the medium category and a display region 1300 for displaying the details of the medium category.

In the display region 1250, a major category 1203 selected in FIG. 11, a medium category 1204, and a button 1202 for returning to the screen of FIG. 11 are displayed at the upper part. Below the medium category 1204, a tab button 1205 for displaying a specific case and a tab button 1206 for displaying a solution case are displayed.

The display regions 1210, 1220, and 1230 are regions for displaying the summaries of the web pages related to the cases (issue cases and solution cases) of the selected tab buttons 1205 and 1206. The web page links to the URL 506 of the social issue case data 127.

The display regions 1210, 1220, and 1230 have the same configuration, and the display regions 1210 will be described below. In the display region 1210, a title 1212 of the web page and a summary 1213 of the web page are displayed. The title 1212 and the summary 1213 of the web page correspond to the contents of the case description 505 of the social issue case data 127. By operating the title 1212 from the terminal 104, it is possible to transition to the URL 506 of the social issue case data 127.

Above the title 1212, the number of the search perspective related to the web page is displayed in the display region 1211. In the illustrated example, the web page of the display region 1210 is displayed to be related to the search perspectives 1, 3 and 4.

Further, in the display region 1250, keywords extracted by the search, a search perspective having a high comprehensive evaluation score, a comprehensive evaluation score, and the like may be displayed. In addition, by displaying the web pages in descending order of comprehensive evaluation scores, the participants 103 can efficiently refer to the social issue cases.

Further, in the display region 1250, the portion including the keyword searched by the social issue case search program 147 may be displayed as a snippet. In addition, if the major or medium category of social issue cases and specific case/solution case are incorrect, a button for correcting them may be provided. In addition, if there is a social issue case that is not suitable for ideation, a button for excluding it may be provided. As shown in FIG. 5, the data in which the major category 502, the medium category 503, and the specific case/solution case 504 of the social issue case data 127 is “exclude” is not searched. Further, points may be added to the feedback 508 of the social issue case data 127 by pressing the fieldwork button (not shown) for the social issue case used for the ideation.

In the display regions 1210, 1220, and 1230 displaying links to web pages of social issue cases, comprehensive evaluation scores and the like may be displayed in addition to the search perspective (1211) having a high score. In addition, by displaying the web pages in descending order of comprehensive evaluation scores, the participants 103 can efficiently refer to the social issue cases.

The pieces of social issue case data 127 displayed in the display regions 1210, 1220, and 1230 are grouped in advance by the major category 502 and the medium category 503, and when the medium category 1204 is switched, it is possible to switch to the social issue case data 127 corresponding to the medium category 503 after the switching.

The display region 1300 displays the details of the medium category. The display region 1300 is a screen displayed as a pop-up or the like when the medium category 1204 of the display region 1250 is operated. The following indications and buttons are arranged on this screen.

Reference numeral 1301 is a major category to which the medium category to be displayed belongs. Reference numeral 1302 is an indication indicating a medium category name of which the details are displayed. Reference numeral 1303 is an indication indicating the region of the medium category. Reference numeral 1304 is a button for closing the medium category detail screen. Reference numeral 1305 is an indication indicating the title of the medium category. Reference numeral 1306 is an indication indicating an illustration showing the medium category. Reference numeral 1307 is an indication indicating the background of the medium category. Reference numeral 1308 is an indication of the economic loss of the medium category. Reference numeral 1309 is an indication indicating the direction of solution. By clicking the indication in the display region 1210, 1220, and 1230, the web page is displayed in the display region 1300.

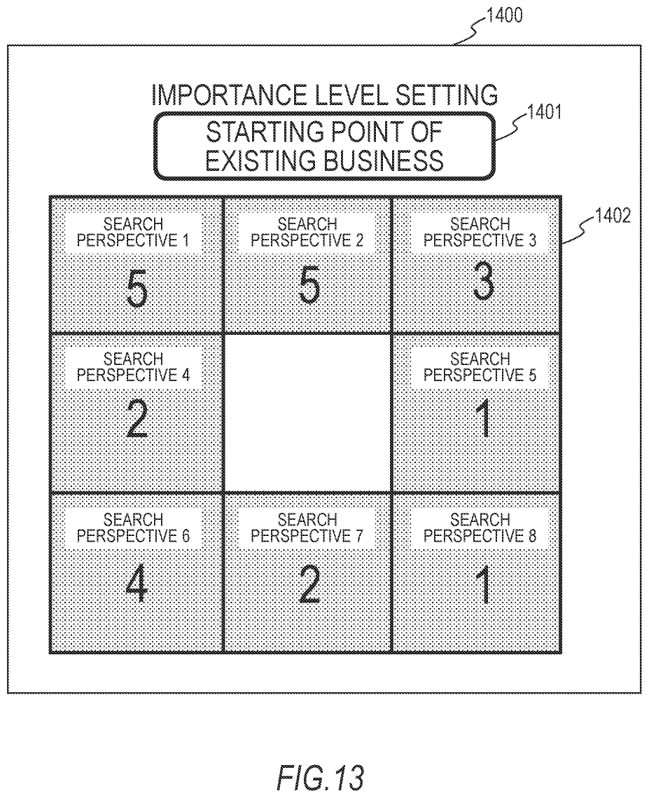

FIG. 13 is a diagram showing an example of a screen for setting the score of importance level (604 to 606). This importance level setting screen 1400 is a screen that can be set from the terminal 104 or the like before starting the workshop or when the discussion on the search perspective is completed.

In the figure, reference numeral 1401 is a button for setting the importance level to be used. In the illustrated example, the state in which the importance level (starting point of existing business) 604 is selected is shown. Reference numeral 1402 is a region in which the score of importance level can be set for each search perspective 602. A user can enter a number by clicking the square of each search perspective, and can change the score. In the illustrated example, the changed score is reflected in the column of the importance level (starting point of existing business) 604 of the search perspective data 128.

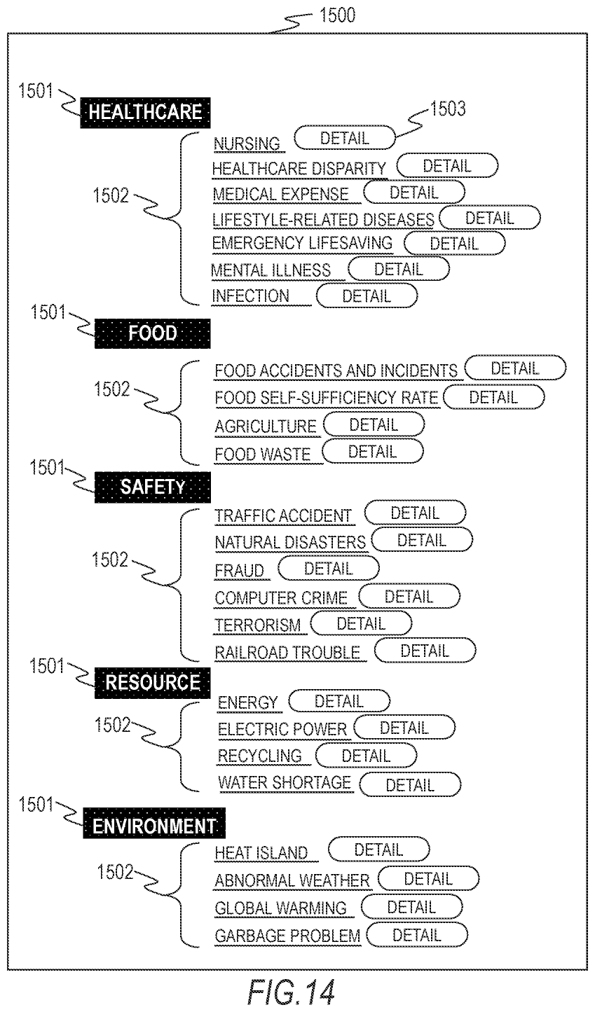

FIG. 14 is a diagram showing an example of a major and medium category display screen transitioning to the social issue case display screen 1200 of FIG. 12. This major and medium category display screen 1500 is displayed on the terminal 104 or the like by the social issue case evaluation program 148, and the following display contents, buttons, and the like are arranged.

In the figure, reference numeral 1501 is a major category name. Reference numeral 1502 is a medium category belonging to the major category 1501. Reference numeral 1503 is a button for displaying the detail screen of the medium category 1502. The participants 103 tend to look at the contents on the screen in order from the top, so by arranging them in descending order of the average values of the comprehensive evaluation scores, the participants 103 can efficiently perform ideation.

In the illustrated example, the average value of the comprehensive evaluation scores is used as an index, but the median value or other statistical values may be used. Further, FIG. 14 may additionally display an average value of the comprehensive evaluation scores, a search perspective having a high comprehensive evaluation score, and the like.

Further, the medium categories 1502 may be displayed in descending order of the amount of the economic loss 405 in the medium category detailed data 126 of FIG. 4. The amount of the economic loss 405 (or economic value) can be treated as a value when ranking the medium categories 1502.

FIG. 15 is a diagram showing an example of a screen for inputting an idea conceived by the participant 103. The following indications, buttons, and the like are arranged on this idea input screen 1600.

In the figure, reference numeral 1601 is a region for inputting articles on social issues that are used as a reference for ideation. A separate button may be added to the display regions 1210, 1220, and 1230 of FIG. 12, and a URL, a title, or the like may be automatically input to the region 1601 when the button is pressed.

In the figure, reference numeral 1602 is a region for inputting a social issue to be solved. Information can be input using a keyboard of the terminal 104 such as a tablet. Reference numeral 1603 is a region for entering the strengths utilized to solve the social issue. Reference numeral 1604 is a region for inputting service idea contents that solve social issues by utilizing strengths.

When the button 1605 is pressed, these pieces of input information can be transmitted to the workshop assistance system 110. The transmitted content is shared on the shared screen and can be discussed by the participants 103. In addition, when the transmitted information is stored in the database 132, by automatically reading the social issues to be solved from the social issue articles and multiplying with the strengths, a learning model for coming up with a service idea can be created. Those calculation results may be recommended as hints for reading social issues articles.

As described above, the workshop assistance system 110 of the present embodiment collects case data (social issue case data 127) related to preset social issues, and classifies the case data by the preset categories. Then, the workshop assistance system 110 holds a workshop discuss social issues for each preset perspective, searches for case data similar to the content of the discussion for each perspective a plurality of times, and calculates a normalized score corresponding to the degree of similarity to obtain search result information.

Then, when the search result information is acquired for all perspectives, the workshop assistance system 110 calculates a comprehensive evaluation score for each importance level (starting point of ideation) set at the time of holding the workshop and each piece of search result information corresponding to the perspective and changes a display order or a display mode of the case data according to the magnitude of the value of the comprehensive evaluation score.

According to the present invention, the content of search target social issue case information (case data) to be presented to the participants 103 can be changed according to the height of the comprehensive evaluation score (index) in consideration of the importance level (starting point of ideation) of the perspective from the contents discussed by the facilitator and the participants in the workshop from a plurality of perspectives. Thus, the participants 103 can efficiently refer to the information (social issue case data 127) that appropriately includes the plurality of perspectives and ideation can be accelerated.

In the above-described embodiment, an example is shown in which the speeches of the facilitator 102 and the participants 103 are collected by the voice collecting device 105 and converted into the text data 130 by the voice recognition program 149, but the present invention is not limited to this. The text data 130 corresponding to the content of the discussion may be collected. For example, the facilitator 102 and the participants 103 may hold a workshop by chat using the terminal 104 and have a discussion with the text data input from the terminals 104. In this case, it is not necessary to perform voice recognition, and natural language processing can be performed on the text data 130 for each perspective.

Further, in the above-described embodiment, an example is shown in which the social issue case collection program 145 of the computation server 140 collects information on web pages including a predetermined social issue, but the present invention is not limited thereto. For example, the social issue case collection program 145 may collect books, papers, and the like that include a predetermined social issue.

Further, in the above-described embodiment, an example is shown in which a workshop is held for social issues and the social issue case data 127 that matches the discussion is presented to the participants, but the present invention is not limited thereto. The present embodiment can be applied to any workshop that discusses issues and presents information to participants.

<Conclusion>

The workshop assistance system of the above-described embodiment can be configured as follows.

(1) A workshop assistance system configured as a computer (140) including: a processing device (CPU 142) that executes a predetermined process; a storage device (memory 143, auxiliary storage device 144) connected to the processing device (CPU 142); and a communication interface (141) connected to the processing device (142), the computer (140) is accessible to issue case data (social issue case data 127) including case information, the workshop assistance system including: an issue case search module (social issue case search program 147) allowing the processing device (142) to collect text corresponding to contents of discussions of participants for each preset perspective (search perspective 602), store the text in text data (130), and calculate an evaluation value from a degree of similarity between the text data (130) and issue case data (127); and an issue case evaluation module (social issue case evaluation program 148) allowing the processing device (142) to determine an output mode of the issue case data (127) based on the evaluation value.

With the above-described configuration, the content of the search target information (issue case data (127)) to be presented to the terminals 104 of the participants 103 can be changed according to the magnitude of the comprehensive evaluation score (index value) in consideration of the importance level of the perspective from the text corresponding to the contents discussed by the facilitator and the participants in the workshop from a plurality of perspectives. Thus, the participants 103 can efficiently refer to the social issue case data 127 that appropriately includes the plurality of perspectives and ideation can be accelerated.

(2) The workshop assistance system according to (1), wherein the computer (140) has search perspective information (search perspective data 128) in which an importance level (importance levels 604 to 606) is set for each starting point of discussion set in advance for each perspective (602), and the issue case evaluation module (148) calculates a comprehensive evaluation value from the evaluation value and the importance level (604 to 606) and determines an output mode of the issue case data (127) based on the comprehensive evaluation value.

With the above-described configuration, the mode presented to the terminals 104 of the participants 103 can be changed according to the comprehensive evaluation score (index value). Thus, the participants 103 can efficiently refer to the social issue case data 127 that appropriately includes the plurality of perspectives, ideation can be accelerated.

(3) The workshop assistance system according to (2), wherein the issue case evaluation module (148) calculates a sum of values obtained by multiplying the evaluation value for each perspective (602) by the importance level (604 to 606) for each perspective (602) as the comprehensive evaluation value, and determines the output mode of the issue case data (127) based on the comprehensive evaluation value.

With the above-described configuration, parameters (604 to 606) are set in advance for each of a plurality of starting points of discussions and each of the plurality of perspectives, and the comprehensive evaluation value is calculated for each perspective with the parameter corresponding to the starting point selected in advance. Thus, the display mode of the social issue case data 127 to be output can be determined based on the comprehensive evaluation value.

(4) The workshop assistance system according to (2), wherein the text data (130) includes text generated by voice recognition of speech data (127) collected from the contents of the discussions of the participants, and the issue case search module (147) divides and stores the speech data (129) when a predetermined trigger is included in the contents of the discussions of the participants.

With the above-described configuration, the speech data 129 is divided for each perspective and stored in the auxiliary storage device 124, and the text data 130 generated from the speech data 129 is divided for each perspective. Thus, the degree of similarity with the content (case description 505) of the social issue case data 127 can be calculated easily.

(5) The workshop assistance system according to (2), wherein the issue case evaluation module (148) determines an output order of the issue case data (127) according to a magnitude of the evaluation value as the output mode.

With the above-described configuration, the mode presented to the terminals 104 of the participants 103 can be changed according to the magnitude of the comprehensive evaluation score (index value). Thus, the participants 103 can efficiently refer to the social issue case data 127 that appropriately includes the plurality of perspectives and ideation can be accelerated.

(6) The workshop assistance system according to (5), wherein the issue case evaluation module (148) groups the issue case data (127) according to a category as the output mode.

With the above-described configuration, the mode presented to the terminals 104 of the participants 103 can be changed according to the magnitude of the comprehensive evaluation score (index value), and the social issue case data 127 is grouped according to the category. Thus, the participants 103 can efficiently refer to the social issue case data 127 that appropriately includes the plurality of perspectives and ideation can be accelerated.

(7) The workshop assistance system according to (6), wherein the category of the issue case data (127) has a major category (502) and a medium category (503), and the medium category (503) is output in an order corresponding to a preset economic loss (405).

With the above-described configuration, since the order of the medium category includes the order corresponding to the economic loss, the category of the social issue case data 127 and the economic value can be evaluated in association with each other.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A workshop assistance system configured as a computer including:
a processing device that executes a predetermined process;
a storage device connected to the processing device; and
a communication interface connected to the processing device,
the computer is accessible to issue case data including case information,
the workshop assistance system comprising:
an issue case search module allowing the processing device to collect text corresponding to contents of discussions of participants for each preset perspective, store the text in text data, and calculate an evaluation value from a degree of similarity between the text data and issue case data; and
an issue case evaluation module allowing the processing device to determine an output mode of the issue case data based on the evaluation value.

2. The workshop assistance system according to claim 1, wherein
the computer has search perspective information including an importance level of each perspective set according to a category of a theme of a workshop, and
the issue case evaluation module calculates a comprehensive evaluation value from the evaluation value and the importance level and determines an output mode of the issue case data based on the comprehensive evaluation value.

3. The workshop assistance system according to claim 2, wherein
the issue case evaluation module calculates a sum of values obtained by multiplying the evaluation value for each perspective by the importance level for each perspective as the comprehensive evaluation value, and determines the output mode of the issue case data based on the comprehensive evaluation value.

4. The workshop assistance system according to claim 2, wherein
the text data includes text generated by voice recognition of speech data collected from the contents of the discussions of the participants, and
the issue case search module divides and stores the speech data when a predetermined trigger is included in the contents of the discussions of the participants.

5. The workshop assistance system according to claim 2, wherein
the issue case evaluation module determines an output order of the issue case data according to a magnitude of the evaluation value as the output mode.

6. The workshop assistance system according to claim 5, wherein
the issue case evaluation module groups the issue case data according to a category as the output mode.

7. The workshop assistance system according to claim 6, wherein
the category of the issue case data has a major category and a medium category, and the medium category is output in an order corresponding to a preset economic loss.

8. A workshop assistance method executed by a computer,
the computer including:
a processing device that executes a predetermined process;
a storage device connected to the processing device; and
a communication interface connected to the processing device,
the computer is accessible to issue case data including case information,
the workshop assistance method comprising:
an issue case search step of allowing the processing device to collect text corresponding to contents of discussions of participants for each preset perspective, store the text in text data, and calculate an evaluation value from a degree of similarity between the text data and issue case data; and
an issue case evaluation step of allowing the processing device to determine an output mode of the issue case data based on the evaluation value.

9. The workshop assistance method according to claim 8, wherein
the computer has search perspective information including an importance level of each perspective set according to a category of a theme of a workshop, and
the issue case evaluation step involves calculating a comprehensive evaluation value from the evaluation value and the importance level and determining an output mode of the issue case data based on the comprehensive evaluation value.

10. The workshop assistance method according to claim 9, wherein
the issue case evaluation step involves calculating a sum of values obtained by multiplying the evaluation value for each perspective by the importance level for each perspective as the comprehensive evaluation value, and determining the output mode of the issue case data based on the comprehensive evaluation value.

11. The workshop assistance method according to claim 9, wherein
the text data includes text generated by voice recognition of speech data collected from the contents of the discussions of the participants, and
the issue case search step involves dividing and storing the speech data when a predetermined trigger is included in the contents of the discussions of the participants.

12. The workshop assistance method according to claim 9, wherein
the issue case evaluation step involves determining an output order of the issue case data according to a magnitude of the evaluation value as the output mode.

13. The workshop assistance method according to claim 12, wherein
the issue case evaluation step involves grouping the issue case data according to a category as the output mode.

14. The workshop assistance method according to claim 13, wherein
the category of the issue case data has a major category and a medium category, and the medium category is output in an order corresponding to a preset economic loss.
